(19) United States
(12) Patent Application Publication
(10) Pub. No.: US 2023/0422151 A1
(43) Pub. Date: Dec. 28, 2023

(54) METHOD FOR SIDELINK COMMUNICATION, FIRST TERMINAL DEVICE, AND SECOND TERMINAL DEVICE

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN)

(21) Appl. No.: 18/463,428

(22) Filed: Sep. 8, 2023

Related U.S. Application Data
(63) Continuation of application No. PCT/CN2021/092869, filed on May 10, 2021.

(51) Int. Cl. H04W 48/08; H04W 72/40

(52) U.S. Cl. CPC H04W 48/08; H04W 72/40

(57) ABSTRACT

A method for sidelink (SL) communication, a first terminal device, and a second terminal device are provided. The method includes the following. A first terminal device receives first information from a second terminal device, where the first information is used to request N system information blocks (SIBs), and N is a positive integer. The first terminal device transmits second information to the second terminal device, where the second information indicates at least one of the N SIBs.

### CROSS-REFERENCE TO RELATED APPLICATION(S)

This application is a continuation of International Application No. PCT/CN2021/092869, filed May 10, 2021, the entire disclosure of which is incorporated herein by reference.

### TECHNICAL FIELD

Embodiments of the disclosure relate to communication technology, and particularly to a method for sidelink (SL) communication, a first terminal device, and a second terminal device.

### BACKGROUND

In the field of communication, user equipment (UEs) can perform communication via a cellular communication interface, i.e., a UE-universal mobile telecommunications system terrestrial radio access network (UE-UTRAN, or Uu for short) interface, and can also directly communicate with each another via a direct communication interface, i.e., a proximity-based service communication (interface) 5 (PC5) interface.

When the UE is out of network coverage or has a poor communication with a random access network (RAN), an indirect communication manner (also referred to as a relay communication manner) may be adopted, that is, a UE that has established connection via both a PC5 interface and a Uu interface can serve as a relay device to perform data transmission between a remote UE and a network. However, the current indirect communication manner still needs to be improved.

### SUMMARY

Embodiments of the disclosure provide a method for sidelink (SL) communication, a first terminal device, and a second terminal device.

In a first aspect, embodiments of the disclosure provide a method for SL communication. The method includes the following. A first terminal device receives first information from a second terminal device, where the first information is used to request N system information blocks (SIBs), and N is a positive integer. The first terminal device transmits second information to the second terminal device, where the second information indicates at least one of the N SIBs.

In a second aspect, embodiments of the disclosure further provide a first terminal device. The first terminal device includes a transceiver, a processor coupled to the transceiver, and a memory configured to store a computer program. The computer program is executed by the processor to cause the first terminal device to perform the following. Receive first information from a second terminal device and transmit second information to the second terminal device, where the first information is used to request N SIBs, and N is a positive integer. Determine the second information, where the second information indicates at least one of the N SIBS.

In a third aspect, embodiments of the disclosure further provide a second terminal device. The second terminal device includes a transceiver, a processor coupled to the transceiver, and a memory configured to store a computer program. The computer program is executed by the processor to cause the second terminal device to perform the following. Determine N SIBs required for the second terminal device. Transmit first information to a first terminal device, where the first information is used to request the N SIBs, and N is a positive integer. Receive second information from the first terminal device, where the second information contains at least one of the N SIBs.

### BRIEF DESCRIPTION OF THE DRAWINGS

FIG. 1 is a schematic diagram illustrating a communication system applicable to the disclosure.

FIG. 2 is another schematic diagram illustrating a communication system applicable to the disclosure.

FIG. 3 is a schematic flow chart illustrating a connection establishment procedure between a remote user equipment (UE) and a relay UE provided in the disclosure.

FIG. 4 is a schematic flow chart illustrating a method for sidelink (SL) communication provided in the disclosure.

FIG. 5 is another schematic flow chart illustrating a method for SL communication provided in the disclosure.

FIG. 6 is another schematic flow chart illustrating a method for SL communication provided in the disclosure.

FIG. 7 is another schematic flow chart illustrating a method for SL communication provided in the disclosure.

FIG. 8 is a schematic diagram illustrating a communication apparatus provided in the disclosure.

FIG. 9 is a schematic structural diagram illustrating a communication device provided in the disclosure.

### DETAILED DESCRIPTION

In order for clarity in elaboration of objectives, technical solutions, and advantages of embodiments of the disclosure, the following will describe technical solutions of embodiments of the disclosure clearly and completely with reference to the accompanying drawings in embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

The terms “first”, “second”, and the like used in the specification, the claims, and the accompany drawings of embodiments of the disclosure are used to distinguish similar objects rather than describe a particular order or a precedence order. It is to be understood that, the data used that way may be interchangeable where appropriate, so that the embodiments of the disclosure described herein can be implemented in sequences other than those illustrated or described herein. In addition, the terms “include”, “comprise”, and “have” as well as variations thereof are intended to cover non-exclusive inclusion. For example, a procedure, a method, a system, a product, or a device that includes a series of steps or units is not necessarily limited to those steps or units that are listed explicitly, but may include other steps or units that are not listed explicitly or include other steps or units that are inherent to such a procedure, a method, a product, or a device.

Technical solutions of embodiments of the disclosure are applicable to various communication systems, for example, a long term evolution (LTE) system, an LTE frequency division duplex (FDD) system, an LTE time division duplex (TDD) system, a universal mobile telecommunications system (UMTS), a worldwide interoperability for microwave access (WiMAX) communication system, a 5th generation (5G) system, a new radio (NR) system, or various potential communication systems, for example, a 6th generation (6G) mobile communication system, and the like. Embodiments of the disclosure are not limited in this regard.

A terminal device in embodiments of the disclosure may be referred to as a terminal or a user equipment (UE). The terminal device may be an access terminal, a subscriber unit, a subscriber station, a mobile station, a remote station, a remote terminal, a mobile device, a user terminal, a terminal device, a wireless communication device, a user agent, or a user device. The terminal device may also be a cellular radio telephone, a cordless telephone, a session initiation protocol (SIP) telephone, a wireless local loop (WLL) station, a personal digital assistant (PDA), a device with wireless communication functions such as a handheld device, a computing device, or other processing devices coupled with a wireless modem, an in-vehicle device, a wearable device, a terminal device in a 5G network, or a terminal device in a future evolved public land mobile network (PLMN), etc. Embodiments of the disclosure are not limited in this regard.

In embodiments of the disclosure, the terminal device may also be a wearable device. The wearable device may also be called a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone. In addition, in embodiments of the disclosure, the terminal device may also be a terminal device in a vehicle to everything (V2X) system or in an internet of things (IoT) system.

A network device in embodiments of the disclosure can communicate with a terminal device. The network device may be a base transceiver station (BTS) in a global system of mobile communication (GSM) or in a code division multiple access (CDMA) system, a node B (NB) in a wideband code division multiple access (WCDMA) system, an evolutional node B (eNB, or eNodeB) in an LTE system, or a radio controller in a cloud radio access network (CRAN) scenario. Alternatively, the network device may be a relay station, an access point, an in-vehicle device, a network device in a 5G network, or a network device in a future evolved PLMN network, etc. Embodiments of the disclosure are not limited in this regard.

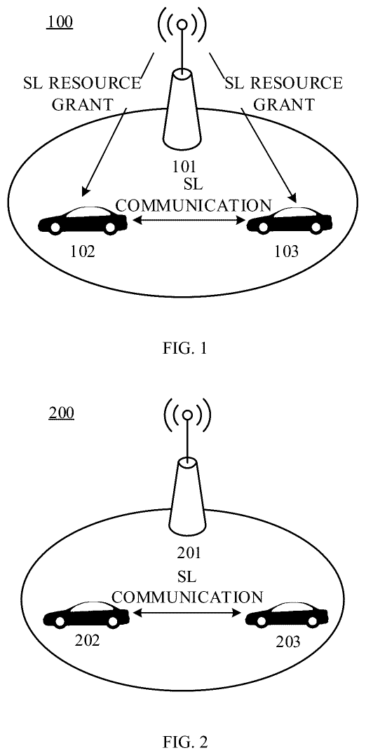

Different from an existing cellular system in which communication data is received or transmitted via a base station, a sidelink (SL) system can use a UE-to-UE direct communication mode in the SL transmission technology, thereby achieving higher spectrum efficiency and lower transmission latency. The 3^{rd} generation partnership project (3GPP) defines two transmission modes: mode A and mode B.
Mode A: FIG. 1 is a schematic diagram illustrating a communication system 100 that can employ SL transmission mode A. As illustrated in FIG. 1, an SL communication resource for a terminal device 102 or an SL communication resource for a terminal device 103 is allocated by a network device 101. For example, the network device 101 can allocate an SL resource for the terminal device 102 via downlink (DL) grant, and the terminal device 102 can transmit data to the terminal device 103 on the SL resource granted. Similarly, the terminal device 103 can also transmit data to the terminal device 102 on the SL resource granted for the terminal device 103 by the network device 101. The network device 101 may allocate an SL resource for single transmission to a terminal device, and may also allocate an SL resource for semi-persistent transmission to the terminal device.
Mode B: FIG. 2 is a schematic diagram illustrating a communication system 200 that can employ SL transmission mode B. As illustrated in FIG. 2, a terminal device 202 and a terminal device 203 are pre-configured with an SL resource pool. When SL communication is needed, the terminal device 202 or the terminal device 203 can select a resource from the resource pool for SL data transmission.

The following will describe the related art and terms involved in the disclosure.

I. LTE device-to-device (D2D) communication or LTE V2X communication

D2D communication is studied at different stages according to the 3GPP.
Proximity based service (ProSe): in release 12 (Rel-12) and release 13 (Rel-13) standard protocols, D2D communication is studied for a ProSe scenario, which mainly aims at public safety services.

In ProSe, by means of configuring a location of a resource pool in a time domain, for example, by means of configuring the resource pool to be discontinuous in the time domain, a UE can discontinuously transmit/receive data on an SL, thereby achieving power saving.
V2X: in Rel-14/Rel-15, a V2X system is studied for a vehicle-to-vehicle (V2V) communication scenario, which is mainly oriented towards V2V communication service or vehicle-to-pedestrian (V2P) communication service with relatively high-speed mobility.

In V2X, since an in-vehicle system has continuous power supply, power efficiency is not a major problem, but data transmission latency is a major problem. Therefore, with respect to system design, a terminal device is required to perform continuous transmission and reception.
Further enhanced D2D (FeD2D): in Rel-14, FeD2D is studied for a scenario where a wearable device accesses a network via a mobile phone, which is mainly oriented towards a scenario of low-speed mobility and low-power access.

In FeD2D, at the pre-research stage, it is concluded by the 3GPP that a base station can configure a discontinuous reception (DRX) parameter(s) for a remote UE via a relay UE. However, since this subject has not entered the standardization stage, there is no conclusion regarding specific details of how to perform DRX configuration.

II. NR V2X

Based on LTE V2X, NR V2X is not limited to a broadcast scenario but is further extended to a unicast scenario and a multicast scenario, and a study is made on the application of V2X in these scenarios.
Similar to LTE V2X, NR V2X can also define two resource grant modes, i.e., mode-1 and mode-2 described above. Further, a user may be in a mixed mode, that is, the user may acquire a resource(s) through both mode-1 and mode-2. Resource acquisition is indicated via SL grant, that is, the SL grant indicates a time-frequency location of a corresponding physical SL control channel (PSCCH) resource and a time-frequency location of a corresponding physical SL shared channel (PSSCH) resource.
Different from LTE V2X, in NR V2X, in addition to a feedback-free hybrid automatic repeat request (HARQ) retransmission initiated automatically by a terminal device, a feedback-based HARQ retransmission is introduced, which is not limited to unicast communication and can also be applicable to multicast communication.

III. SL-Based UE-to-Network Relay

In Rel-13 ProSe, a layer-3 UE-to-network relay is introduced in the 3GPP. A remote UE can access a network via a relay UE, and the relay UE may be responsible for internet protocol (IP) layer relay to perform data transmission between the remote UE and the network. The remote UE and the relay UE are connected via an SL.

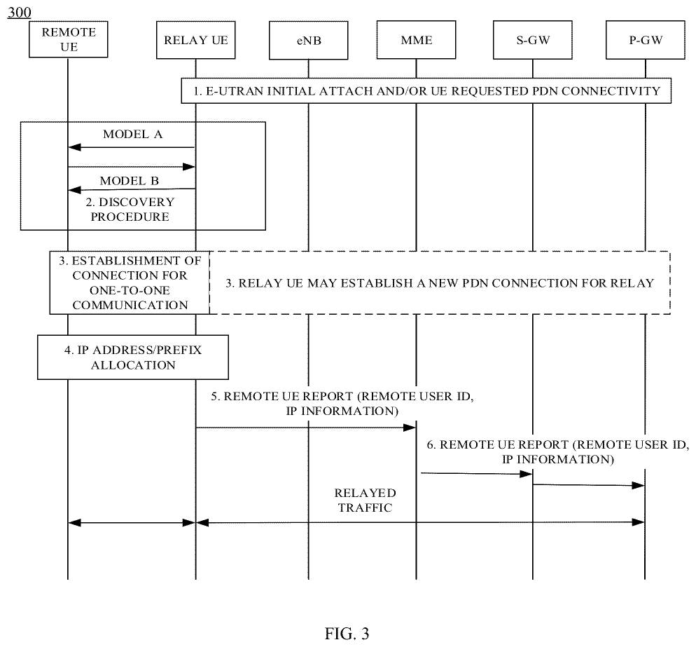

Exemplarily, a connection establishment procedure between the remote UE and the relay UE is illustrated in FIG. 3, including but not limited to the following operations.
1. The relay UE performs evolved universal terrestrial radio access network (E-UTRAN) initial attach and/or UE requested public data network (PDN) connectivity with an eNB, a mobility management entity (MME), a serving gateway (S-GW), a PDN gateway (P-GW).
2. The remote UE and the relay UE perform a discovery procedure.

The remote UE and the relay UE can discover each other via model A or model B.
3. The remote UE and the relay UE establish a connection for one-to-one communication. Optionally, the relay UE can establish a new protocol data unit (PDU) connection for relay.
4. The remote UE and the relay UE perform IP address/prefix allocation.
5. The relay UE transmits a remote UE report to the MME via the eNB. The remote UE report may contain remote user identifier (ID) and IP information.

The relay UE reports the remote UE ID and IP information to the network. According to the reported information, the network can know an association relationship between the relay UE and the remote UE, so as to perform corresponding bearer/session management and configuration. Therefore, the remote UE can be connected to the network via the relay UE.
6. Upon reception of the remote UE report, the MME forwards the remote UE report to the S-GW, and then the S-GW transmits the remote UE report to the P-GW.

In the case where a node in the network acquires the remote UE report, the remote UE can communicate with the network via relay of the relay UE, thereby implementing relay transmission of data of the remote UE.

In Rel-15 FeD2D, a layer-2 UE-to-network relay is studied in the 3GPP. That is, a remote UE can access a network via a relay UE, the relay UE may be responsible for adaptation layer relay (above a radio link control (RLC) layer and below a packet data convergence protocol (PDCP) layer) to perform data transmission between the remote UE and the network, and the remote UE and the relay UE are connected via an SL, which is not standardized subsequently.

IV UTRAN-UE (Uu) Interface System Information (SI) Broadcast

In a mobile communication system, SI contents may be defined in the manner of an information block, and SI may be divided into a master information block (MIB), system information block (SIB)1, and SIBn (n=2, . . . , 14), where SIB2˜SIB14 may be referred to as other system information (OSI). The MIB is mainly used to notify a UE of whether the UE is allowed to reside and whether the SIB1 is broadcasted. The SIB1 mainly contains parameters for a current cell such as parameters related to cell selection and access control parameters, SIB2˜SIB5 are related to cell reselection, SIB6˜SIB8 are used to broadcast information related to public safety such as earthquake and tsunami warning, etc., and SIB9 provides coordinated universal time (UTC) for global positioning system (GPS) initialization or UE internal clock synchronization, etc.

The MIB may be broadcasted via a broadcast control channel (BCCH) mapped to a broadcast channel (BCH), where the BCCH is a logical channel. The SIB1 and the OSI are broadcasted via a BCCH mapped to a downlink-shared channel (DL-SCH), which on the user plane, are transparent for a packet data convergence protocol (PDCP) layer, a radio link control (RLC) protocol, and a medium access control (MAC) layer in a layer-2 protocol. That is, after abstract syntax notation one (ASN.1) encoding is performed on the SIB1 and the OSI at a radio resource control (RRC) layer, the SIB1 and the OSI are directly transmitted to a physical (PHY) layer for processing.

According to the foregoing illustration, SI contains information related to public safety, UTC, etc. However, in the UE-to-network relay communication, there is no effective mechanism for a remote UE to perform SI acquisition. The remote UE can perform on demand SI acquisition via a relay UE.

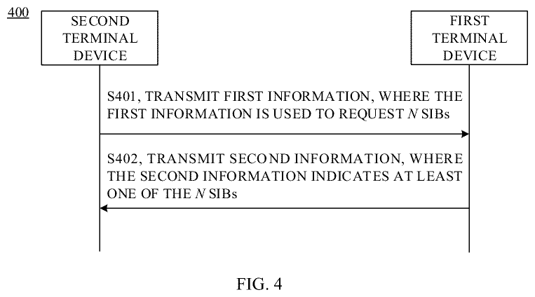

FIG. 4 is a schematic flow chart illustrating a method 400 for SL communication provided in the disclosure. As illustrated in FIG. 4, a second terminal device may be a remote terminal, a first terminal device may be a relay terminal, and the first terminal device can provide a relay service for the second terminal device.

S401, the second terminal device transmits first information to the first terminal device, where the first information is used to request N SIBs.

Accordingly, the first terminal device receives the first information from the second terminal device, where N is a positive integer. Optionally, the second terminal device is in an idle state, or in an inactive state, or in a connected state.

In an embodiment, the second terminal device can determine the N SIBs required on demand, and transmit the first information to the first terminal device, so as to notify, via the first information, the first terminal device of the N SIBs required for the second terminal device.

For example, in the case where the second terminal device determines that the second terminal device needs to acquire SIB6, SIB7, and SIB8, that is, SIB s related to public safety, the second terminal device can transmit the first information to the first terminal device, where the first information may contain an ID of each of the SIB6, the SIB7, and the SIB8. Upon reception of the first information from the second terminal device, the first terminal device determines, according to the ID of each of the SIB6, the SIB7, and the SIB8 in the first information, that the second terminal device needs to acquire the SIB6, the SIB7, and the SIB8. However, the disclosure is not limited in this regard.

In another embodiment, the second terminal device can determine the N SIBs required on demand, and then determine, according to network connection status of the first terminal device, an SIB granularity requested via the first information.

Optionally, when the network connection status of the first terminal device is the connected state, the second terminal device determines that the SIB granularity requested via the first information is an SIB.

Optionally, when the network connection status of the first terminal device is the idle state or the inactive state, the second terminal device determines that the SIB granularity requested via the first information is an SI, where the SI contains one or more SIBs.

In another embodiment, the second terminal device can determine the N SIBs required on demand, and then determine, according to the network connection status of the first terminal device, the number (quantity) of SIBs requested via the first information.

Optionally, the second terminal device determines, according to the network connection status of the first terminal device, the number of the SIBs requested via the first information as follows. When the network connection status of the first terminal device is the connected state, the second terminal device determines that the first information contains one of the N SIB S.

That is, in the case where the network connection status of the first terminal device is the connected state, the second terminal device can request one SIB from the first terminal device each time. For example, in the case where the second terminal device determines that the second terminal device needs multiple SIBs according to requirements, when the first terminal device is in the connected state, the second terminal device can transmit multiple request information to the first terminal device, where each request information (i.e., an example of the first information) is used to request one SIB required for the second terminal device.

Optionally, the second terminal device determines, according to the network connection status of the first terminal device, the number of the SIBs requested via the first information as follows. When the network connection status of the first terminal device is the idle state or the inactive state, the second terminal device determines that the first information contains the N SIBs, where N is an integer greater than or equal to 1.

That is, in the case where the network connection status of the first terminal device is the idle state or the inactive state, the second terminal device can request, via the first information, from the first terminal device the N SIB S required for the second terminal device.

By way of explanation rather than limitation, the first information may be on demand SI acquisition or on demand SI request.

Optionally, the first information may be carried in a proximity-based service communication interface 5 (PC5)-radio resource control (RRC) message (i.e., PC5-RRC message).

Optionally, the first information contains a first SI request list, where the first SI request list contains an ID of each of the N SIBs.

Upon reception of the first information from the second terminal device, the first terminal device acquires the first SI request list, and determines, according to the ID of each of the SIBs in the first SI request list, SIBs required for the second terminal device; and/or upon reception of the first information from the second terminal device, the first terminal device acquires, according to content of the first information, one SIB or the N SIBs required for the second terminal device.

S402, the first terminal device transmits second information to the second terminal device, where the second information indicates at least one of the N SIBs.

Accordingly, the second terminal device receives the second information from the first terminal device.

Upon reception of the first information from the second terminal device, the first terminal device determines the N SIBs required for the second terminal device. The first terminal device can provide at least one of the N SIBs for the second terminal device via the second information.

Optionally, the first terminal device can determine, according to the network connection status of the first terminal device, the number of SIBs required to be indicated by the second information.

When the network connection status of the first terminal device is the connected state, the first terminal device determines that the second information may contain one of the N SIBs. That is, in the case where the network connection status of the first terminal device is the connected state, each time the first terminal device can transmit to the second terminal device one SIB required for the second terminal device. For example, when the first terminal device is in the connected state, the first terminal device can transmit multiple information to the second terminal device, where each information (i.e., an example of the second information) indicates one SIB required for the second terminal device.

When the network connection status of the first terminal device is the idle state or the inactive state, and Nis greater than 1, the first terminal device determines that the second information may contain multiple SIBs in the N SIBs.

In an optional embodiment, the first terminal device determines, according to the first information, whether the first terminal device has N valid local SIBs, where the N valid local SIBs are SIBs required for the second terminal device.

It is to be noted that, a valid SIB may also be referred to as a legal SIB, which is not limited in the disclosure.

Optionally, in the case where the first terminal device has R valid local SIB s (hereinafter, R SIBs), the first terminal device transmits the second information to the second terminal device, where the N SIBs includes the R SIBs, and R is a positive integer and is less than or equal to N.

For example, it may be specified that when the first terminal device has at least one SIB valid and the at least one SIB valid is at least one SIB in the N SIB s, the first terminal device transmits the second information to the second terminal device, where the second information contains the at least one SIB (i.e., the R valid local SIBs). However, the disclosure is not limited in this regard.

For another example, it may be specified that when the first terminal device has the N SIBs locally and the N SIBs all are valid, the first terminal device transmits the second information to the second terminal device, where the second information contains the N SIBs. However, the disclosure is not limited in this regard.

Optionally, when the first terminal device does not have M SIB s valid, the first terminal device acquires the M SIBs from the network device, where the N SIBs required for the second terminal device include the M SIBs, and M is a positive integer and is less than or equal to N.

That is, in the case where the first terminal device determines that the first terminal device does not have M valid local SIB s which are the M SIBs required for the second terminal device, the first terminal device acquires one or more of the M SIB s from the network device.

Optionally, the first terminal device acquires the M SIBs from the network device as follows. The first terminal device transmits ninth information to the network device, where the ninth information is used to request one or more of the M SIBS.

For example, when si-BroadcastStatus of a third SIB in the M SIBs is set to notBroadcasting, the first terminal device can transmit the ninth information to the network device, where the ninth information is used to request the third SIB. Upon reception of the ninth information, the network device transmits the third SIB to the first terminal device. However, the disclosure is not limited in this regard.

The first terminal device can determine, according to the first information from the second terminal device, one or more SIBs to be requested via the ninth information. However, the disclosure is not limited in this regard.

Optionally, the first terminal device acquires the M SIBs from the network device as follows. The first terminal device receives one or more of the M SIBs from the network device. For example, when si-BroadcastStatus of a fourth SIB in the M SIBs is not set to notBroadcasting, the first terminal device can acquire the fourth SIB according to a broadcast message received from the network device. However, the disclosure is not limited in this regard.

When the M SIBs valid are acquired from the network device, the first terminal device can transmit the M SIBs to the second terminal device.

When the M SIBs valid are acquired from the network device, the first terminal device can transmit the second information to the second terminal device, where the second information contains the N SIB s required for the second terminal device. Alternatively, when the first information is acquired by the first terminal device, the first terminal device determines that the first terminal device does not have the M SIBs valid, and that the first terminal device has N-M SIBs valid except the M SIBs in the N SIBs. In this case, the first terminal device transmits the second information to the second terminal device, where the second information contains the N-M SIBs valid. Upon reception of the M SIBs valid from the network device, the first terminal device forwards the M SIBs to the second terminal device. However, the disclosure is not limited in this regard.

In an embodiment, when the first terminal device is in the connected state, the ninth information is carried in a DedicateSIBRequest message.

In another embodiment, when the first terminal device is in the idle state or in the inactive state, the first terminal device can request SI by performing a random access (RA) procedure. That is, the first terminal device transmits the ninth information to the network device during the RA procedure.

Optionally, the ninth information is carried in an SI request message, where the SI request message is used to request SIBs requested by the first terminal device. The SIBs requested by the first terminal device includes one or more of the M SIBs (i.e., SIBs indicated by the ninth information) required for the second terminal device. The SIBs requested by the first terminal device may further include at least one SIB required for the first terminal device and/or at least one SIB required for a third terminal device, where the first terminal device is configured to provide a relay service for the third terminal device.

In an example, the SI request message is used to request merely one or more of the M SIBs required for the second terminal device. After transmitting the SI request message to the network device, the first terminal device can receive from the network device feedback information on the SI request message, where the feedback information contains one or more of the M SIBs required for the second terminal device. The first terminal device forwards the feedback information to the second terminal device, that is, the first terminal device does not need to acquire SIBs in the feedback information through splitting the feedback information, and the first terminal device as a relay can forward the feedback information to the second terminal device.

In another example, the SI request message contains one or more of the M SIB s required for the second terminal device and at least one SIB required for the first terminal device. After transmitting the SI request message to the network device, the first terminal device can receive from the network device feedback information on the SI request message, where the feedback information contains SIBs required for the second terminal device and SIBs required for the first terminal device. When the SIBs required for the second terminal device are acquired by the first terminal device through reading the feedback information, the first terminal device can forward the SIBs required for the second terminal device to the second terminal device.

Optionally, the ninth information contains an SIB list, where the SIB list contains an ID of each of the SIBs requested by the first terminal device.

For example, the SIB list contains one or more of: an ID of each of the M SIBs required for the second terminal device, an ID of each of the SIBs required for the first terminal device, and an ID of each of SIBs required for other remote UEs connected with the first terminal device.

The network device can transmit, according to an SIB request message from the first terminal device, the SIBs requested by the first terminal device to the first terminal device in a unicast or broadcast manner.

Optionally, when the first terminal device does not locally have a valid second SIB required for the second terminal device and cannot acquire the second SIB from a network, the first terminal device can transmit tenth information to the second terminal device, where the tenth information indicates that the first terminal device cannot provide the second SIB for the second terminal device, and the N SIBs include the second SIB.

Optionally, the first terminal device can transmit the tenth information to the second terminal device before or after the first terminal device receives the first information.

That is, in the case where the first terminal device determines, according to the first information, that the second terminal device requires the N SIBs, but the first terminal device cannot acquire the second SIB required for the second terminal device, the first terminal device can notify, via the tenth information, the second terminal device that the first terminal device cannot provide the second SIB.

For example, in the case where the second terminal device notifies, via the first information, the first terminal device that the second terminal device requires SIB1, SIB2, and SIB9, but the first terminal device cannot acquire the SIB9, the first terminal device can transmit the tenth information to the second terminal device, where the tenth information indicates that the first terminal device cannot provide the SIB9 for the second terminal device. However, the disclosure is not limited in this regard.

Optionally, in the case where the network device notifies the first terminal device that the network device cannot provide the second SIB, and the first terminal device determines that the first terminal device cannot acquire the second SIB from the network, the first terminal device can notify, via the tenth information, the second terminal device that the first terminal device cannot provide the second SIB. In this case, the second terminal device does not further request the second SIB from the first terminal device.

It is to be noted that, the second SIB may be MIB or any one of SIB1 to SIB14 that the first terminal device cannot acquire, which is not limited in the disclosure.

According to the solutions described above, the second terminal device can notify, via the first information, the first terminal device of the SIBs required for the second terminal device, so that the first terminal device can provide the SIBs for the second terminal device according to requirements of the second terminal device. Therefore, the second terminal device can acquire the SIBs on demand. Further, based on determination on validity of local SI, the first terminal device can provide the second terminal device with valid SIBs required for the second terminal device, so that the second terminal device can acquire the valid SIBs, and/or the first terminal device can acquire the SIBs from the network device and forward the SIBs to the second terminal device, so that the second terminal device can acquire the valid SIBs.

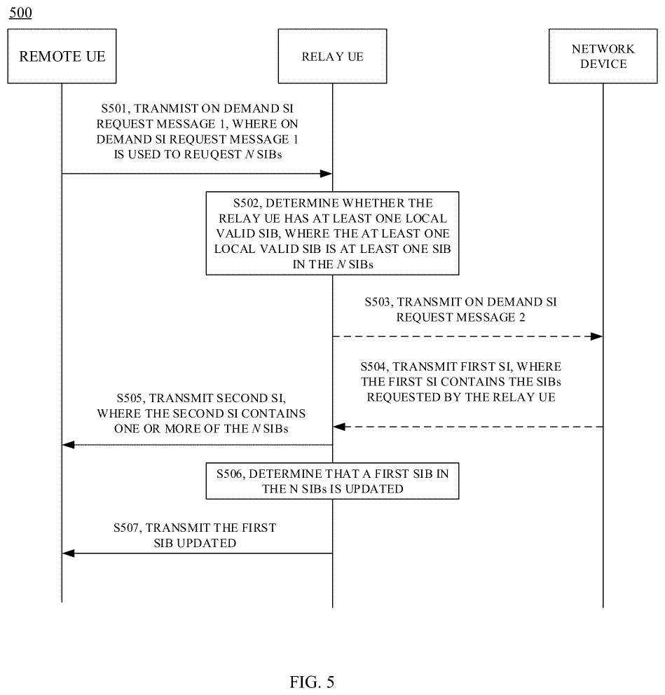

FIG. 5 is a schematic flow chart illustrating a method 500 for SL communication provided in the disclosure. In the method 500 for SL communication, upon reception of an on demand SI request message from a remote UE via a PC5, a relay UE can transmit a valid (or, referred to as legal) SIB(s) to the remote UE, and upon reception of update SI from a base station, the relay UE can forward the updated SI to the remote UE until a relay link between the relay UE and the remote UE is released. The method 500 for SL communication may include, but is not limited to, the following operations.

S501, the remote UE transmits on demand SI request message 1 to the relay UE, where on demand SI request message 1 is used to request N SIBs.

Accordingly, the relay UE receives on demand SI request message 1 from the remote UE. The remote UE requests on demand from the relay UE the N SIBs via on demand SI request message 1.

By way of explanation rather than limitation, on demand SI request message 1 is a PC5-RRC message.

On demand SI request message 1 may contain an ID of each of the N SIBs. Alternatively, on demand SI request message 1 contains an SIB request list, where the SIB request list contains the ID of each of the N SIB s. Upon reception of on demand SI request message 1, the relay UE determines, according to the ID of each of the SIBs in on demand SI request message 1, the N SIBs required for the remote UE.

S502, the relay UE determines whether the relay UE has at least one valid local SIB, where the at least one valid local SIB is at least one SIB in the N SIBs.

The relay UE determines, according to on demand SI request message 1, the N SIBs required for the remote UE. The relay UE checks whether the relay UE has at least one valid local SIB, where the at least valid local SIB is at least one SIB in the N SIBs.

In the case where the relay UE determines that the relay UE does not have M valid local SIBs (hereinafter, M SIBs) required for a second terminal device, the relay UE can acquire one or more of the M SIBs from a network device. The N SIBs include the M SIBs, and M is less than or equal to N. That is, the M SIBs are SIBs requested by the remote UE, and the relay UE does not locally have the M SIBs valid.

Optionally, a relay can determine, according to si-BroadcastStatus of each of the M SIBs, a manner in which one or more of the M SIBs are acquired.

For example, when the M SIBs include at least one SIB of which si-BroadcastStatus is not set to notBroadcasting, the relay UE can acquire at least one of the M SIBs according to a broadcast message received from the network device. When the M SIBs include at least one SIB of which the si-BroadcastStatus is set to notBroadcasting, the relay UE can acquire at least one of the M SIBs by performing an operation at S503.

S503, the relay UE transmits on demand SI request message 2 to the network device.

Accordingly, the network device receives on demand SI request message 2 from the relay UE.

On demand SI request message 2 contains SIBs requested by the relay UE, where the SIBs requested by the relay UE includes one or more of the M SIBs. Alternatively, SI requested by the relay UE further include SIBs required for the relay UE, and/or, the SIBs requested by the relay UE further include SIBs required for other remote UE for which the relay UE is configured to provide a relay service.

Optionally, the relay UE can request SI2 from the network device on demand according to an RRC state of the relay UE (i.e., an example of network connection status).

In an embodiment, when the relay UE is in a connected state, the relay UE transmits a DedicatedSIBRequest message (i.e., an example of on demand SI request message 2) to the network device.

In another embodiment, when the relay UE is in an idle state or in an inactive state, the relay UE acquires SI by performing an RA procedure. The relay UE transmits on demand SI request message 2 to the network device during the RA procedure.

S504, the network device transmits first SI to the relay UE, where the first SI contains the SIBs requested by the relay UE.

Accordingly, the relay UE receives the first SI from the network device. The network device may transmit the first SI to the relay UE in a unicast or broadcast manner according to on demand SI request message 2. However, the disclosure is not limited in this regard.

Optionally, the first SI contains an SIB list, where the SIB list contains the SIBs requested by the relay UE.

When the M SIBs valid are acquired by the relay UE based on the first SI and/or SI broadcasted by a network, the relay UE locally has the N SIBs valid and then performs an operation at S505. Alternatively, when the relay UE determines at S502 that the relay UE locally has the N SIBs required for the remote UE, the relay UE performs the operation at S505. Alternatively, when the relay UE determines at S502 that the relay UE locally has the M SIBs in the N SIBs required for the remote UE, the relay UE performs the operation at S505.

S505, the relay UE transmits second SI to the remote UE, where the second SI contains one or more of the N SIBs.

Accordingly, the remote UE receives the second SI from the relay UE, so that the remote UE can obtain one or more valid SIBs, where the one or more valid SIBs are one or more SIBs in the N SIBs required for the remote UE.

After S505, in the case where the relay UE discovers that an SIB in the N SIBs required for the remote UE is updated or that an SIB in an SIB request list for the remote UE is updated, the relay UE transmits to the remote UE the SIB updated as illustrated at S506 and S507.

S506, the relay UE determines that a first SIB in the N SIBs is updated.

Optionally, the relay UE receives a short message from the network device. When the short message indicates SI update, the relay UE can monitor SI update in a next SI modification period. When the relay UE discovers that the first SIB is updated, the relay UE determines that the first SIB required for the remote UE is updated, and the relay UE can transmit the first SIB updated to the remote UE.

For example, the N SIBs required for the remote UE include SIB3 (i.e., an example of the first SIB). When the relay UE receives from the network device the short message that indicates SI update, the relay UE monitors SI update in a next SI modification period. When a cell reselection parameter carried in the SIB3 is updated, the relay UE transmits the SIB3 updated to the remote UE.

It is to be noted that, the first SIB may be MIB or any one of SIB1 to SIB14 updated by the network, which is not limited in the disclosure.

S507, the relay UE transmits the first SIB updated to the remote UE.

Accordingly, the remote UE receives the first SIB updated from the relay UE, so that the remote UE can acquire a valid SIB in time.

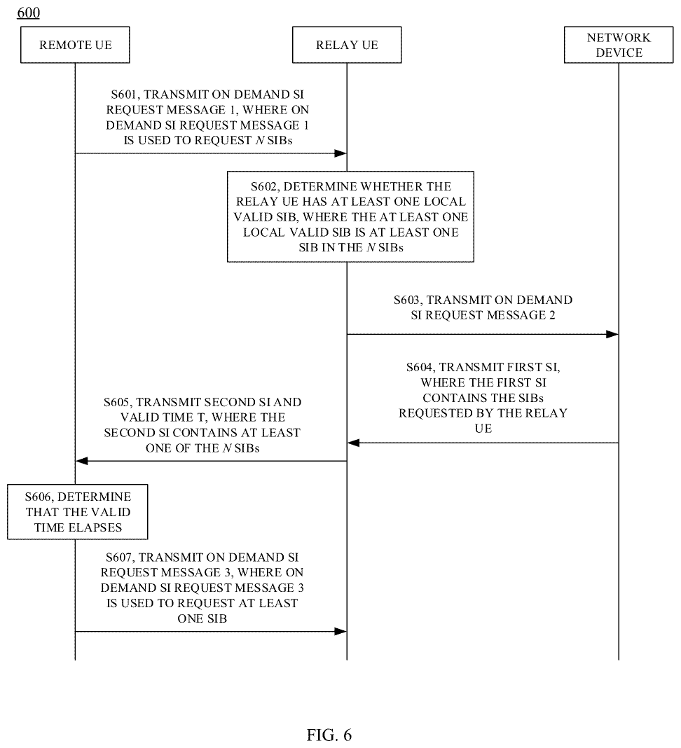

FIG. 6 is a schematic flow chart illustrating a method 600 for SL communication provided in embodiments of the disclosure. In the method 600 for SL communication, upon reception of an on demand SI request message 1 from a remote UE via a PC5, a relay UE can transmit valid SI and SI valid time T to the remote UE, and the remote UE considers that the SI valid time from the relay UE is T. Upon elapse of the valid time, when the remote UE still needs to acquire an SIB, the remote UE can transmits on demand SI request message 3 to the relay UE.

The method 600 for SL communication may include, but is not limited to, an operation at S601 to an operation at S607, where the operation at S601 to the operation at S604 correspond to the operation at S501 to the operation at S504 in the embodiments illustrated in FIG. 5, respectively. For specific embodiments regarding the operation at S601 to the operation at S604, reference can be made to the foregoing illustration of FIG. 5, which will not be repeated herein for the sake of simplicity.

S605, the relay UE transmits second SI and valid time T to the remote UE, where the second SI contains at least one of the N SIBs.

Accordingly, the remote UE receives from the relay UE the second SI and valid time T, where valid time T indicates a SI valid duration. Valid time T at S605 is a time period in which each SIB in the second SI is valid. That is, a valid duration of each SIB in the second SI is equal to T, and when the valid time elapses, each SIB in the second SI is considered as failure or as not valid. The valid time may also be referred to as SI valid time.

It is to be understood that, the relay UE can make the second SI and the SI valid time be carried in a same message and then transmit the message to the remote UE. Alternatively, the relay UE can make the second SI and the SI valid time be respectively carried in different messages and then transmit the different messages to the remote UE. The disclosure is not limited in this regard.

For example, the relay UE may first transmit the second SI to the remote UE, and then transmit the SI valid time to the remote UE. Alternatively, the relay UE may first transmit the SI valid time to the remote UE, and then transmit the second SI to the remote UE. The disclosure is not limited in this regard.

As an alternative to the operation at S605, it may be feasible for the relay UE to only transmit the second SI to the remote UE, and the SI valid time may be specified in a protocol, and/or pre-configured for the remote UE by the relay UE via a PC5-RRC message, and/or pre-configured for the remote UE by a network. However, the disclosure is not limited in this regard.

When SI valid time T is determined by the remote UE, the remote UE determines that each SIB in the second SI is valid within SI valid time T since reception of the second SI. After SI valid time T (i.e., SI valid time T elapses) since reception of the second SI, or a time interval since reception of the second SI exceeds SI valid time T, the remote UE determines that the second SI becomes invalid.

S606, the remote UE determines that the valid time elapses.

When the time interval since reception of the second SI exceeds T, the remote UE determines that the SI valid time elapses and determines that each SIB in the second SI becomes invalid. In the case where the remote UE needs to further require SIBs, the remote UE determines the SIBs required and performs an operation at S607.

S607, the remote UE transmits on demand SI request message 3 to the relay UE, where on demand SI request message 3 is used to request at least one SIB.

Accordingly, the relay UE receives on demand SI request message 3 from the remote UE and determines whether the relay UE has a valid local SIB(s) required for the remote UE. Subsequent operations are similar to the operation at S602 to the operation at S605, and thus for the subsequent operations, reference can be made to the foregoing illustration, which will not be repeated herein for the sake of simplicity.

According to the solutions described above, the relay UE can provide for the remote UE an SIB(s) required for the remote UE, and notify the remote UE of valid time T in which each SIB provided for the remote UE is valid, so that the remote UE can determine validity of SI according to valid time T.

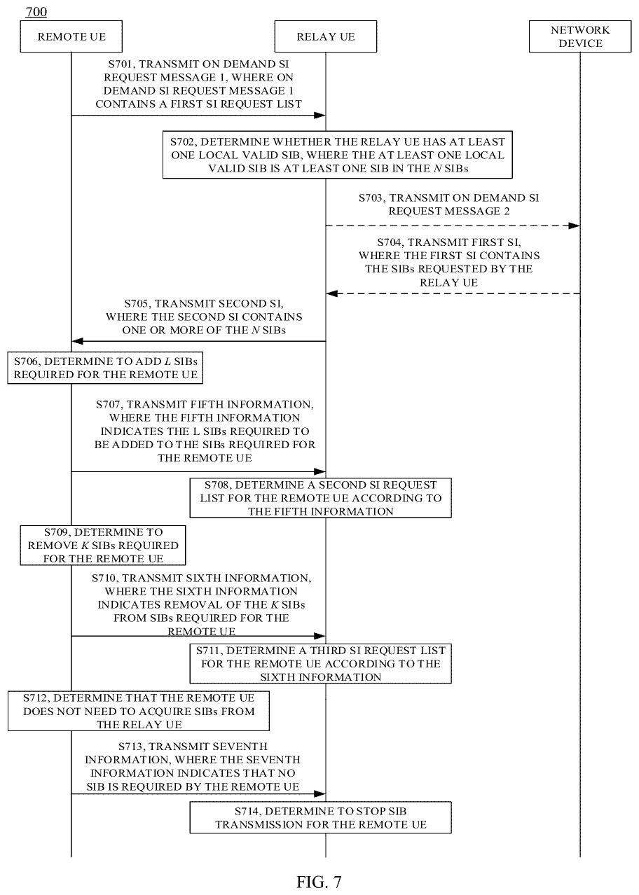

FIG. 7 is a schematic flow chart illustrating a method 700 for SL communication provided in embodiments of the disclosure. In the method 700 for SL communication, a relay UE and a remote UE each maintain an on demand SI request list from the remote UE, and the remote UE informs the relay UE to update the on demand SI request list via an add indication, and/or a remove indication, and/or a release indication. The method 700 for SL communication may include, but is not limited to, the following operations.

S701, the remote UE transmits on demand SI request message 1 to the relay UE, where on demand SI request message 1 contains a first SI request list.

Accordingly, the relay UE receives on demand SI request message 1 from the remote UE and determines the first SI request list for the remote UE. The first SI request list may also be referred to as on demand SI request list 1, which is not limited in the disclosure. The on demand SI request list contains an ID of each of N SIBs required for the remote UE. The relay UE can determine, according to the ID of each of SIBs in the first SI request list, the N SIBs required for the remote UE.

An operation at S702 to an operation at S705 each correspond to the operation at S502 to the operation at S505 in the embodiments illustrated in FIG. 5. For specific embodiments regarding the operation at S702 to the operation at S705, reference can be made to the foregoing illustration of FIG. 5, which will not be repeated herein for the sake of simplicity.

When the first SI request list for the remote UE is acquired by the relay UE, the relay UE stores the first SI request list. Optionally, after S705, in the case where an SIB indicated by the first SI request list is updated (for example, it is determined based on a short message from a network device that the SIB is updated), the relay UE can notify the remote UE of the updated SIB required for the remote UE.

In the case where SIBs required for the remote UE change, for example, in the case where the remote UE needs to add an SIB(s) required for the remote UE, the remote UE and the relay UE can perform corresponding operations at S706 to S708; in the case where the remote UE needs to remove an SIB(s) required for the remote UE, the remote UE and the relay UE can perform corresponding operations at S709 to S711; in the case where the remote UE determines that no SIB is required by the remote UE, the remote UE and the relay UE can perform corresponding operations at S712 to S714. It is to be noted that, an execution order in which the remote UE and the relay UE perform operations to add, remove, and release an SIB(s) required for the remote UE is not limited in the disclosure.

S706, the remote UE determines to add L SIB S required for the remote UE.

S707, the remote UE transmits fifth information to the relay UE, where the fifth information indicates the L SIBs required to be added to the SIBs required for the remote UE.

Accordingly, the relay UE receives the fifth information from the remote UE and determines, according to the fifth information, the L SIBs required to be added for the remote UE.

Optionally, the fifth information contains an SI add list, which is also called onDemandSIAddList. The SI add list contains an ID of each of the L SIBs.

S708, the relay UE determines a second SI request list for the remote UE according to the fifth information.

The second SI request list contains the N SIBs in the first SI request list and Q SIBs, where the L SIBs indicated by the fifth information include the Q SIBs, the N SIB S do not include the Q SIBs, and Q is a positive integer.

That is, the relay UE obtains the second SI request list by adding the Q SIBs to the first SI request list, where the L SIBs include the Q SIBs, and the N SIBs does not include the Q SIBs.

In the case where the fifth information contains the SI add list, the relay UE obtains the second SI request list by adding the Q SIBs to the first request list, where the Q SIB S are in the SI add list but not in the first SI request list.

In the case where the relay UE determines that the Q SIB S need to be added to the SIBs required for the remote UE, the relay UE can determine whether the Q SIBs are locally in the relay UE and whether the Q SIBs are valid when the Q SIBs are locally in the relay UE. When the Q SIBs are locally in the relay UE and the Q SIB S locally in the relay UE are valid, the relay UE can transmit the Q SIBs to the remote UE. When part of the Q SIBs is locally in the relay UE and the part of the Q SIBs locally in the relay UE is valid or none of the Q SIBs is locally in the relay UE, the relay UE can request valid SIBs from the network device and notify the remote UE of the valid SIBs required for the remote UE. The relay UE may transmit one or more of the Q SIBs to the remote UE. Alternatively, the relay UE may transmit one or more of the N SIBs and one or more of the Q SIBs to the remote UE. The disclosure is not limited in this regard.

S709, the remote UE determines to remove K SIBs required for the remote UE.

S710, the remote UE transmits sixth information to the relay UE, where the sixth information indicates removal of the K SIBs from SIBs required for the remote UE.

Accordingly, the relay UE receives the sixth information from the remote UE.

Optionally, the sixth information contains an SI remove list, which is also called onDemandSIRemoveList, where the SI remove list contains an ID of each of the K SIB S.

S711, the relay UE determines a third SI request list for the remote UE according to the sixth information.

The third SI request list does not contain P SIBs.

When neither the remote UE nor the relay UE performs the operation at S706 to the operation at S708, an SI request list for the remote UE maintained by both the relay UE and the remote UE is the first SI request list.

The relay UE can obtain the third SI request list by removing the P SIBs from the first SI request list according to the sixth information, where the N SIBs in the first SI request list and the K SIBs indicated by the sixth information both include the P SIB S, and P is a positive integer. In the case where the sixth information contains the SI remove list, the relay UE can obtain the third SI request list by removing, from the first SI request list, the P SIBs in both the SI remove list and the first SI request list.

In the case where the remote UE and the relay UE perform the operation at S706 to the operation at S708, the SI request list for the remote UE maintained by both the relay UE and the remote UE is the second SI request list. The relay UE can obtain the third SI request list by removing the P SIBs from the second SI request list according to the sixth information. N+Q SIBs in the second SI request list and the K SIBs indicated by the sixth information both include the P SIBs, where P is a positive integer. In the case where the sixth information contains the SI remove list, the relay UE can obtain the third SI request list by removing, from the second SI request list, the P SIBs in both the SI remove list and the second SI request list.

S712, the remote UE determines that the remote UE does not need to acquire SIBs from the relay UE.

S713, the remote UE transmits seventh information to the relay UE, where the seventh information indicates that no SIB is required by the remote UE.

Accordingly, the relay UE receives the seventh information from the remote UE.

Optionally, the seventh information contains an SI release list, which is also called onDemandSIReleaseList.

S714, the relay UE determines, according to the seventh information, to stop SIB transmission for the remote UE.

For example, the relay UE can remove/release the SI request list for the remote UE, and does not need to forward SIBs to the remote UE prior to further reception of an SI request message from the remote UE.

According to the solutions of the disclosure, a synchronization mechanism for on demand SI acquisition between the remote UE and the relay UE is provided. The relay UE can notify the remote UE that SI required for the relay UE are updated, and the remote UE can notify the relay UE that SIB requirement of the remote UE is updated. Therefore, the remote UE can acquire SI on demand.

From the foregoing, the methods provided in embodiments of the disclosure are described in detail with reference to FIG. 4 to FIG. 7, and apparatuses provided in embodiments of the disclosure are introduced in the following.

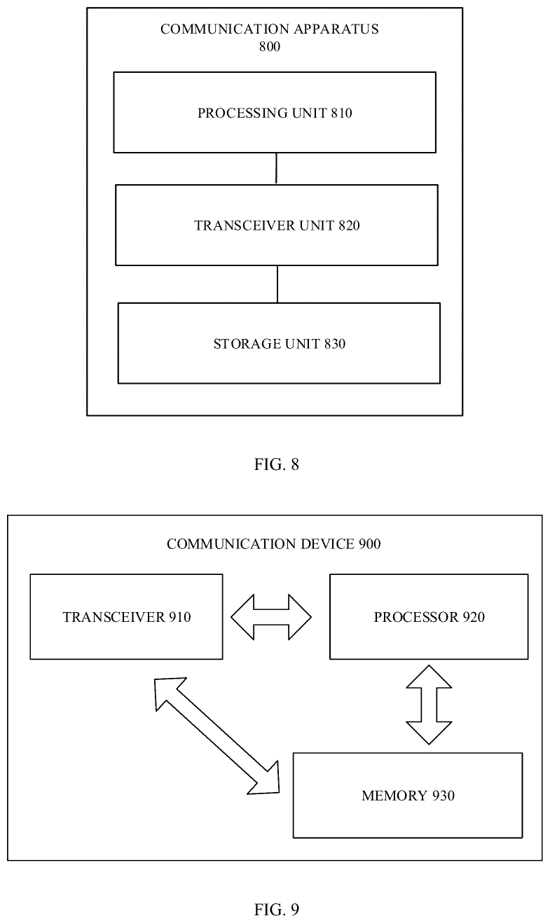

FIG. 8 is a schematic block diagram of a communication apparatus provided in embodiments of the disclosure. As illustrated in FIG. 8, the communication apparatus 800 may include a processing unit 810 and a transceiver unit 820.

In a possible design, the communication apparatus 800 may correspond to the first terminal device, i.e., UE, in the method embodiments above, or may correspond to a chip configured at (or configured for) the first terminal device.

It is to be understood that, the communication apparatus 800 may correspond to the first terminal device in the method 400, method 500, method 600, and method 700 according to the embodiments of the disclosure, and the communication apparatus 800 may include a unit(s) configured to perform the methods performed by the first terminal device in the method 400, method 500, method 600, and method 700 illustrated in FIG. 4, FIG. 5, FIG. 6, and FIG. 7. In addition, various units, and the above and other operations and/or functions of the communication apparatus 800 are respectively intended for implementing corresponding operations in the method 400, method 500, method 600, and method 700 illustrated in FIG. 4, FIG. 5, FIG. 6, and FIG. 7.

It is further to be understood that, when the communication apparatus 800 is a chip configured at (or configured for) the first terminal device, the transceiver unit 820 in the communication apparatus 800 may be an input/output interface or a circuit of the chip, and the processing unit 810 in the communication apparatus 800 may be a processor in the chip.

Optionally, the processing unit 810 in the communication apparatus 800 may be configured to process instructions or data, so as to implement corresponding operations.

Optionally, the communication apparatus 800 may further include a storage unit 830. The storage unit 830 may be configured to store the instructions or data, and the processing unit 810 may be configured to execute the instructions or data stored in the storage unit, so that the communication apparatus can implement the corresponding operations. The transceiver unit 820 in the communication apparatus 800 may correspond to a transceiver 910 in a terminal device 900 illustrated in FIG. 9, and the storage unit 830 may correspond to a memory in the terminal device 900 illustrated in FIG. 9.

It is to be understood that, specific procedures for various units to execute the foregoing various operations have been described in detail in the foregoing method embodiments, which will not be repeated herein for the sake of simplicity.

It is further to be understood that, when the communication apparatus 800 is the first terminal device, the transceiver unit 820 in the communication apparatus 800 may be implemented via a communication interface (for example, a transceiver or the input/output interface). For example, the transceiver unit 820 in the communication apparatus 800 may correspond to the transceiver 910 in the terminal device 900 illustrated in FIG. 9. The processing unit 810 in the communication apparatus 800 may be implemented via at least one processor. For example, the processing unit 810 in the communication apparatus 800 may correspond to a processor 920 in the terminal device 900 illustrated in FIG. 9, and the processing unit 810 in the communication apparatus 800 may be implemented via at least one logic circuit.

In another possible design, the communication apparatus 800 may correspond to the second terminal device, i.e., UE, in the method embodiments above, or may correspond to a chip configured at (or configured for) the second terminal device.

It is to be understood that, the communication apparatus 800 may correspond to the second terminal device in the method 400, method 500, method 600, and method 700 according to the embodiments of the disclosure, and the communication apparatus 800 may include a unit configured to perform the methods performed by the second terminal device in the method 400, method 500, method 600, and method 700 illustrated in FIG. 4, FIG. 5, FIG. 6, and FIG. 7. In addition, various units, and the above and other operations and/or functions of the communication apparatus 800 are respectively intended for implementing corresponding operations in the method 400, method 500, method 600, and method 700 illustrated in FIG. 4, FIG. 5, FIG. 6, and FIG. 7.

It is further to be understood that, when the communication apparatus 800 is a chip configured at (or configured for) the second terminal device, the transceiver unit 820 in the communication apparatus 800 may be an input/output interface or a circuit of the chip, and the processing unit 810 in the communication apparatus 800 may be a processor in the chip.

Optionally, the processing unit 810 in the communication apparatus 800 may be configured to process instructions or data, so as to implement corresponding operations.

Optionally, the communication apparatus 800 may further include a storage unit 830. The storage unit 830 may be configured to store the instructions or data, and the processing unit 810 may be configured to execute the instructions or data stored in the storage unit, so that the communication apparatus can implement the corresponding operations. The transceiver unit 820 in the communication apparatus 800 in the communication apparatus 800 may correspond to a transceiver 910 in the terminal device 900 illustrated in FIG. 9, and the storage unit 830 may correspond to a memory in the terminal device 900 illustrated in FIG. 9.

It is to be understood that, specific procedures for various units to execute the foregoing various operations have been described in detail in the foregoing method embodiments, which will not be repeated herein for the sake of simplicity.

It is further to be understood that, when the communication apparatus 800 is the second terminal device, the transceiver unit 820 in the communication apparatus 800 may be implemented via a communication interface (for example, a transceiver or the input/output interface). For example, the transceiver unit 820 in the communication apparatus 800 may correspond to the transceiver 910 in the terminal device 900 illustrated in FIG. 9. The processing unit 810 in the communication apparatus 800 may be implemented via at least one processor. For example, the processing unit 810 in the communication apparatus 800 may correspond to a processor 920 in the terminal device 900 illustrated in FIG. 9, and the processing unit 810 in the communication apparatus 800 may be implemented via at least one logic circuit.

FIG. 9 is a schematic structural diagram illustrating a terminal device 900 provided in embodiments of the disclosure. The terminal device 900 is applicable to the systems illustrated in FIG. 1 and FIG. 2, so as to perform functions of the first terminal device or the second terminal device in the method embodiments above. As illustrated in FIG. 9, the terminal device 900 includes a processor 920 and a transceiver 910. Optionally, the terminal device 900 further includes a memory 930. The processor 920, the transceiver 910, and the memory can transmit control and/or data signals by communicating with each other through an internal connection route. The memory is configured to store a computer program. The processor 920 is configured to execute the computer program stored in the memory, so as to control the transceiver 910 to transmit and receive signals.

The processor 920 above may be integrated with the memory into a processing apparatus, and the processor 920 is configured to execute program codes stored in the memory so as to implement the functions above. In a specific embodiment, the memory may also be integrated into the processor 920 or be independent of the processor 920. The processor 920 may correspond to the processing unit illustrated in FIG. 8.

The transceiver 910 above may correspond to the transceiver unit illustrated in FIG. 8. The transceiver 910 may include a receiver (or referred to as a receiver circuit) and a transmitter (or referred to as a transmitter circuit). The receiver is configured to receive a signal, and the transmitter is configured to transmit the signal.

It is to be understood that, the terminal device 900 illustrated in FIG. 9 can implement various operations related to the terminal device in the embodiments of method 400, method 500, method 600, and method 700 illustrated in FIG. 4, FIG. 5, FIG. 6, and FIG. 7. Operations and/or functions of various modules of the terminal device 900 are respectively intended for implementing corresponding operations in the method embodiments above. For details, reference can be made to the description of the method embodiments above, which will not be repeated herein.

The processor 920 may be configured to perform actions that are implemented internally by the terminal device described in the foregoing method embodiments, and the transceiver 910 may be configured to perform actions of transmitting by the terminal device to a network device or actions of receiving from the network device, as described in the foregoing method embodiments. For details, reference can be made to the description of the foregoing method embodiments, which will not be repeated herein.

Optionally, the terminal device 900 above may further include a power supply, where the power supply is configured to supply power to various components or circuits in the terminal device.

A processing apparatus is further provided in embodiments of the disclosure. The processing apparatus includes a processor and an interface, where the processor is configured to perform the method described in any one of the method embodiments above.

It is to be understood that, the processing apparatus above may be one or more chips. For example, the processing apparatus may be a field programmable gate array (FPGA), may be an application specific integrated circuit (ASIC), may also be a system on chip (SoC), may also be a central processor unit, may also be a network processor (NP), may also be a digital signal processor (DSP), may also be a micro controller unit (MCU), and may also be a programmable logic device (PLD) or other integrated chips.

During embodiment, each operation of the foregoing methods may be completed by a hardware integrated logic circuit in the processor or an instruction in the form of software. The operations of the method disclosed in embodiments of the disclosure may be directly implemented by a hardware processor, or may be performed by hardware and software modules in the processor. The software module can be located in a storage medium mature in the skill such as a random access memory (RAM), a flash memory, a read-only memory (ROM), a programmable ROM (PROM), an electrically erasable programmable memory, registers, or the like. The storage medium is located in the memory. The processor reads the information in the memory, and completes the operations of the method described above with the hardware thereof, which will not be illustrated in detail here to avoid repetition.

It is to be noted that, the processor in embodiments of the disclosure may be an integrated circuit chip with signal processing capabilities. During embodiment, each operation of the foregoing method embodiments may be completed by a hardware integrated logic circuit in the processor or an instruction in the form of software. The processor above may be a general-purpose processor, a DSP, an ASIC, an FPGA, or other programmable logic devices, discrete gates or transistor logic devices, discrete hardware components. The methods, operations, and logic blocks disclosed in embodiments of the disclosure can be implemented or executed. The general-purpose processor may be a microprocessor, or the processor may also be any conventional processor or the like. The operations of the method disclosed in embodiments of the disclosure may be directly implemented by a hardware decoding processor, or may be performed by hardware and software modules in the decoding processor. The software module can be located in a storage medium mature in the skill such as an RAM, a flash memory, an ROM, a PROM, an electrically erasable programmable memory, registers, or the like. The storage medium is located in the memory. The processor reads the information in the memory, and completes the operations of the method described above with the hardware thereof.

According to the method provided in embodiments of the disclosure, a computer program product is further provided in the disclosure. The computer program product includes computer program codes. When being executed by one or more processors, the computer program codes cause an apparatus equipped with the processor(s) to perform the method described in the embodiments.

According to the method provided in embodiments of the disclosure, a computer-readable storage medium is further provided in the disclosure. The computer-readable storage medium is configured to store program codes. When being executed by one or more processors, the program codes cause an apparatus equipped with the processor(s) to perform the method described in the embodiments.

According to the method provided in embodiments of the disclosure, a system is further provided in the disclosure. The system includes one or more network devices described above. The system may further include one or more terminal devices described above.

In several embodiments provided in the disclosure, it will be appreciated that the devices and methods disclosed may be implemented in various other manners. For example, the device embodiments described above are merely illustrative, e.g., the division of modules is only a division of logical functions, and other manners of division may be available in practice, e.g., multiple modules may be combined or may be integrated into another system, or some features may be ignored or skipped. In other respects, the coupling or direct coupling or communication connection as illustrated or discussed may be an indirect coupling or communication connection through some interfaces or modules, and may be electrical, mechanical, or otherwise.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for sidelink (SL) communication, comprising:
receiving, by a first terminal device, first information from a second terminal device, wherein the first information is used to request N system information blocks (SIBs), and Nis a positive integer; and
transmitting, by the first terminal device, second information to the second terminal device, wherein the second information indicates at least one of the N SIBs.

2. The method of claim 1, wherein prior to release of a relay connection between the first terminal device and the second terminal device, the method further comprises:
transmitting, by the first terminal device, third information to the second terminal device when a first SIB in the N SIBs is updated, wherein the third information indicates the first SIB updated.

3. The method of claim 2, wherein the third information contains the first SIB updated or a first list;
wherein the first list contains the first SIB updated.

4. The method of claim 1, wherein the first information contains a first system information (SI) request list.

5. The method of claim 4, wherein the first SI request list contains an identifier (ID) of each of the N SIBs.

6. The method of claim 1, further comprising:
determining, by the first terminal device according to the first information, whether the first terminal device has one or more valid local SIBs, wherein the one or more valid local SIBs are one or more SIBs in the N SIBs; and
transmitting, by the first terminal device, the second information to the second terminal device comprises:
transmitting, by the first terminal device, the second information to the second terminal device when the first terminal device has R SIB S valid, wherein the N SIBs comprise the R SIBs, and R is a positive integer and is less than or equal to N.

7. The method of claim 6, further comprising:
acquiring, by the first terminal device, one or more of M SIBs from a network device when the first terminal device does not have the M SIBs valid, wherein the N SIBs comprise the M SIBs, and M is a positive integer and is less than or equal to N.

8. The method of claim 7, wherein acquiring, by the first terminal device, the one or more of the M SIBs from the network device comprises:
transmitting, by the first terminal device, ninth information to the network device, wherein the ninth information is used to request the one or more of the M s; and/or
receiving, by the first terminal device, the one or more of the M SIBs from the network device.

9. A first terminal device comprising:
a transceiver;
a processor coupled to the transceiver; and
a memory configured to store a computer program;
wherein execution of the computer program by the processor causes the first terminal device to:
receive first information from a second terminal device, and transmit second information to the second terminal device, wherein the first information is used to request N system information blocks (SIBs), and Nis a positive integer; and
determine the second information according to the first information, wherein the second information indicates at least one of the N SIBs.

10. The first terminal device of claim 9, wherein execution of the computer program by the processor further causes the first terminal device to:
transmit third information to the second terminal device when a first SIB in the N SIBs is updated, prior to release of a relay connection between the first terminal device and the second terminal device, wherein the third information indicates the first SIB updated.

11. The first terminal device of claim 10, wherein the third information contains the first SIB updated or a first list;
wherein the first list contains the first SIB updated.

12. The first terminal device of claim 9, wherein the first information contains a first system information (SI) request list.

13. The first terminal device of claim 12, wherein the first SI request list contains an identifier (ID) of each of the N SIBs.

14. The first terminal device of claim 9, wherein execution of the computer program by the processor further causes the first terminal device to:
determine, according to the first information, whether the first terminal device has one or more valid local SIBs, wherein the one or more valid local SIBs are one or more SIBs in the N SIBs; and
transmit the second information to the second terminal device when the first terminal device has R SIBs valid, wherein the N SIBs comprise the R SIB S, and R is a positive integer and is less than or equal to N.

15. The first terminal device of claim 14, wherein execution of the computer program by the processor further causes the first terminal device to:
acquire one or more of M SIBs from a network device when the first terminal device does not have the M SIBs valid, wherein the N SIBs comprise the M SIBs, and M is a positive integer and is less than or equal to N.

16. The first terminal device of claim 15, wherein execution of the computer program by the processor further causes the first terminal device to:
transmit ninth information to the network device, wherein the ninth information is used to request the one or more of the M SIBs; and/or
receive the one or more of M SIBs from the network device.

17. A second terminal device comprising:
a transceiver;
a processor coupled to the transceiver; and
a memory configured to store a computer program;
wherein execution of the computer program by the processor causes the second terminal device to:
determine N system information blocks (SIBs) required for the second terminal device; and
transmit first information to a first terminal device, wherein the first information is used to request the N SIBs, and N is a positive integer;
receive second information from the first terminal device, wherein the second information indicates at least one of the N SIBs.

18. The second terminal device of claim 17, wherein execution of the computer program by the processor further causes the second terminal device to:
receive third information from the first terminal device prior to release of a relay connection between the first terminal device and the second terminal device, wherein the third information indicates a first SIB updated, and the N SIBs comprise the first SIB.

19. The second terminal device of claim 18, wherein the third information contains the first SIB updated or a first list;
wherein the first list contains the first SIB updated.

20. The second terminal device of claim 17, wherein the first information contains a first system information (SI) request list.
